(19) United States
(12) Patent Application Publication
(10) Pub. No.: US 2005/0191387 A1
(43) Pub. Date: Sep. 1, 2005

(54) Method for increasing shelf life of baked goods

(75) Inventors: Tonya J. Armstrong, Muscatine, IA (US); Celeste Sullivan, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 10/889,481

(22) Filed: Jul. 12, 2004

Related U.S. Application Data
(60) Provisional application No. 60/486,685, filed on Jul. 11, 2003.

(51) Int. Cl. A23G 3/00

(52) U.S. Cl. 426/94; 426/524

(57) ABSTRACT

The invention provides a method of reducing moisture loss and a method of reducing shrinkage in a frozen baked good. Each method comprises preparing a baked good comprising a pre-gelatinized modified granular starch and freezing the baked good, the starch being present in said baked good in an amount effective to reduce moisture loss or shrinkage upon freezing relative to the absence of the starch.

### RELATED APPLICATION

This is a nonprovisional application of U.S. provisional application Ser. No. 60/486,685, which is incorporated herein by reference in its entirety.

### FIELD OF THE INVENTION

This invention pertains to a method of preparing a frozen baked good.

### BACKGROUND OF THE INVENTION

Modified food starches, particularly pre-gelatinized modified food starches, have been used for many years in bakery applications to improve shelf-life. Modified pre-gelatinized food starches have been the most successful in improving the shelf-life of cakes that contain a greater amount of sugar than flour (i.e., “high-ratio” cakes) by improving moisture retention and textural properties of the cake at room temperature. For example, Karaoglu, et al., Starch/Starke, 53, 162-169 (2001) describes the effects of using modified food starches on cake quality. Using four different starches, the Karaoglu reference demonstrates that a 10% level of pre-gelatinized starch improved cake volume and delayed staling at room temperature for seven days. In addition, Belshaw, Cereal Foods World, 25, 648 (1980) discloses a study in which 4% of a drum dried modified starch improved the 48-hour shelf-life of high-ratio cakes. The use of pre-gelatinized waxy maize starches in cakes has also been demonstrated to increase cake batter viscosity and moisture retention (see, e.g., National Starch and Chemical, “Light cakes and crunchy snacks—Manipulating the moisture in bakery products,” Innovations in Food Technology, 2001). Lorenz and Kulp, Cereal Chem., 58, 49-52 (1981), describe the use of heat-treated potato and wheat starches in high-ratio yellow cakes to improve cake volume and texture. Similarly, U.S. Pat. Nos. 4,157,406 and 4,259,362 disclose improved cake properties as a result of using heat-treated starch with intact granules in cake formulations. The use of these currently available pre-gelatinized modified food starches in baked goods subject to freezing, however, typically results in severe cake shrinkage and moisture loss.

### BRIEF SUMMARY OF THE INVENTION

The invention provides a method of reducing moisture loss in a frozen baked good, which method comprises preparing a baked good comprising a pre-gelatinized (i.e., pre-swollen granules but still retaining a granular structure) modified granular dent corn starch and freezing the baked good, said starch being present in said baked good in an amount effective to reduce moisture loss upon freezing relative to the absence of said starch. The invention also provides a method of reducing shrinkage of a frozen baked good, which method comprises preparing a baked good comprising a pre-gelatinized modified granular dent corn starch and freezing the baked good, said starch being present in said baked good in an amount effective to reduce shrinkage upon freezing relative to the absence of said starch. The preferred starch is a granular, pre-gelatinized hydroxypropyl distarch phosphate. Frozen baked goods made in accordance with this method also are encompassed by the invention.

### DETAILED DESCRIPTION OF THE PREFERRED EMBODIMENTS

The starches used in conjunction with the invention may be selected from among the hydroxypropyl, acetyl, and octenyl succinate derivatized starches, with hydroxypropyl starches being preferred. The starches may be derivatized to any suitable degree of substitution (DS). Generally, the starches of the invention should be crosslinked using any suitable crosslinking agent. Preferably, the starch is a non-waxy starch, most preferably a dent corn starch. In accordance with highly preferred embodiments of the invention, the starch is not a drum-dried starch, but is a cold-water swelling granular starch. The starch generally is prepared by providing an aqueous slurry of the starch (preferably a slightly acidic or basic slurry) and spray-cooking the starch under conditions of moisture and heat sufficient to swell the starch granules, but wherein the starch remains substantially completely in granular form, i.e., wherein a majority and preferably substantially all of the starch granules remain intact. The starch preferably is not prepared using an alcohol-swelling process.

The invention provides a method of reducing moisture loss and a method reducing shrinkage in a frozen baked good. Each method comprises preparing a baked good which comprises a pre-gelatinized (i.e., pre-swollen granules but still retaining a granular structure) modified granular dent corn starch, and freezing the baked good. Any suitable pre-gelatinized modified granular starch can be used in connection with the inventive method. The preferred pre-gelatinized modified granular dent corn starch used in the inventive method preferably is a hydroxyalkyl starch (see, e.g., U.S. Pat. No. 6,051,700 and U.S. patent application Ser. No. 09/863,928 both of which are incorporated by reference in their entireties), and more preferably is a hydroxypropyl distarch phosphate. Desirably, the pre-gelatinized modified granular dent corn starch is a modified food starch available under the trademark INSCOSITY® B658 or B656 from Grain Processing Corporation (Muscatine, Iowa). The INSCOSITY® starches are pre-gelatinized, yet they maintain their granular structure. By this it is contemplated that the starch granules are swollen and are generally translucent or semi-translucent. Those skilled in the art will appreciate that such starches may be made via known methods. The INSCOSITY® starch itself is not the invention. Other food-grade modified pre-gelatinized cross-linked starches may be used in connection with the invention.

INSCOSITY B656 and B658 also have a lower viscosity than most modified waxy-maize pre-gelatinized starches, allowing the baked good manufacturer to add greater amounts of starch to a particular formulation without adverse effects. Those skilled in the art will appreciate that high batter viscosities typically produce inferior crumb structure (e.g., excessive tunneling or large holes), which leads to toughness, a rubbery cake texture, and can ultimately increase moisture loss in the cake.

The pre-gelatinized modified granular dent corn starch may be used in connection with other ingredients, including surfactants, polymers, fillers, and other ingredients as may be desired in a frozen baked good application. As surfactants, it is contemplated that those such as mono- and di-glycerides, di-acetyl tartaric esters of fatty acids, propylene glycol mono- and di-esters of fatty acids, polysorbate 60, calcium or sodium stearoyl 2 lactylate, lactyl stearate, sodium stearoyl fumarate, succinylate monoglycerides, ethoxylated mono- and di-glycerides, and the like may be used. In certain applications, the starch may be used in conjunction with other natural polymers such as gums, cellulose derivatives, starch derivatives, starch hydrolysis products, microorganism products, or with food-grade synthetic polymers. Surfactants, polymers, and fillers can be included in the baked good in any suitable amounts. For example, the baked good desirably comprises about 0.1% w/w to about 5% w/w surfactant, about 0.05% w/w to about 2% w/w polymer, and about 0.1% w/w to about 15% w/w filler.

The baked good can be prepared using any suitable method known in the art. Generally a batter is prepared and baked, and the baked product may be subsequentially modified (e.g. by adding frosting). When preparing the baked good, the pre-gelatinized modified granular dent corn starch is included in the baked good formulation in any suitable amount, but preferably in an amount effective to reduce moisture loss and/or shrinkage of the baked good when frozen. In this respect, the baked good desirably comprises about 0.5% w/w to about 10% w/w (e.g., about 1% w/w, about 5% w/w, or about 8% w/w) of the pre-gelatinized modified granular dent corn starch. Most preferably, the baked good comprises about 0.75% w/w to about 1% w/w (e.g., about 0.8% w/w, about 0.9% w/w, or bout 0.95% w/w) of the pre-gelatinized modified granular dent corn starch.

Following preparation of the baked good comprising a pre-gelatinized modified granular dent corn starch, the baked good is frozen. The baked good can be frozen under normal conditions or can be flash-frozen. The baked good typically is maintained at a temperature of about 0° C. or less (e.g., about −2° C. or less, about −5° C. or less, or about −10° C. or less). The baked good can be frozen for any desired amount of time. Preferably, the baked good is frozen for at least about 2 months or more (e.g., about 3 months, about 5 months, or about 7 months). Ideally, the baked good is frozen for not longer than about 9 months.

Moisture loss can be measured using any suitable technique. Preferably, moisture loss is measured by comparing the weight of the baked good before freezing to the weight of the baked good after being frozen for a desired time period. Desirably, the moisture loss is about 5% w/w or less (e.g., about 2% w/w or less, about 1% w/w or less, or even about 0.8% w/w or less). It is believed that the starch of the invention inhibits moisture less by inhibiting sublimation of water upon freezing, or by inhibiting formation of ice crystals which would then separate from the baked goods. Likewise, the degree of shrinkage of a frozen baked good can be measured using any suitable method. Typically and preferably, shrinkage is measured by comparing the height of the baked good before freezing and after freezing. Desirably, the shrinkage is about 5% or less (e.g., about 4% or less, about 3% or less, or even about 2% or less).

The inventive method can be used to reduce moisture loss and/or shrinkage in any suitable baked good subjected to freezing. Examples of suitable baked goods include, but are not limited to, high-ratio layer cakes, muffins, and cookies. Preferably, the inventive method is used to reduce moisture loss and/or shrinkage in high-ratio layer cakes.

### EXAMPLE 1

This example further illustrates the invention but should not be construed as in any way limiting its scope. This example demonstrates a method of reducing moisture loss and shrinkage in a frozen baked good.

Yellow cake formulations were prepared containing 0.5-1.0% w/w of each of the following food starches: unmodified dent corn starch (comparative), hydroxypropyl acid thinned corn starch, hydroxypropyl distarch phosphate, pre-gelatinized hydroxypropyl acid thinned corn starch, pre-gelatinized modified waxy maize corn starch, INSCOSITY® B656, and xanthan gum. Characteristics such as moisture, weight, volume, symmetry, batter temperature, batter viscosity, batter specific gravity, pH, crust and crumb analysis, sensory analysis, and textural analysis were assessed using standard methods known in the art. In particular, textural analysis was conducted on a TA.XT2 Texture Analyzer using the AIB standard procedure for cake firmness. Textural analysis was conducted on cakes stored at ambient temperature (72° F.) at days 1, 3, and 8, and on cakes removed from the freezer and thawed after 6 weeks, 3 months, and 9 months of frozen storage. Moisture loss and shrinkage in each cake formulation was assessed following nine months of freezing. The results of the moisture loss and shrinkage tests are set forth in Table 1 and 2. (Examples other than INSCOSITY® represent controls.)

TABLE 1

| | Moisture Loss |
|---|---|
| Starch Tested | (%) |
| no starch | 3.2 |
| unmodified dent corn starch | 2.7 |
| hydroxypropyl acid thinned corn | 1.1 |
| starch | |
| hydroxypropyl distarch phosphate | 1.1 |
| pre-gelatinized hydroxypropyl acid | 1.9 |
| thinned corn starch | |
| pre-gelatinized modified waxy maize | 1.4 |
| corn starch | |
| INSCOSITY ® B656 | 0.6 |
| Xanthan gum | 1.5 |

TABLE 2

| | Shrinkage (in height) |
|---|---|
| Starch Tested | (%) |
| no starch | 13.4 |
| unmodified dent corn starch | 5.4 |
| hydroxypropyl acid thinned corn | 31.3 |
| starch | |
| hydroxypropyl distarch phosphate | 12.4 |
| pre-gelatinized hydroxypropyl acid | 2.5 |
| thinned corn starch | |
| pre-gelatinized modified waxy maize | 9.3 |
| corn starch | |
| INSCOSITY ® B656 | 1.6 |
| Xanthan Gum | 10.8 |

As a result of these experiments, the optimal amount of INSCOSITY® B656 modified food starch required to improve the shelf-life of the frozen cake formulations was determined to be between 0.75% w/w and 1.0% w/w.

The results of this example demonstrate that the inventive method reduces moisture loss and shrinkage in frozen high-ratio cake products. Indeed, the results demonstrate that inclusion of a pre-gelatinized modified granular dent corn starch, such as INSCOSITY® B656, was the most effective of the starches tested in reducing moisture loss and shrinkage.

### EXAMPLE 2

Comparison of instant starch viscosity of various commercial starches, including the preferred commercial starch of Tables 1 and 2, is provided in Table 3 below. For each starch example, mixtures were made as follows: 5% starch, 15% granulated sugar, and 80% Culligan water were mixed at room temperature for about 10 minutes and viscosity in centipoises was then measured using a Brookfield viscometer, #4 spindle, 20 rpm at room temperature. The preferred commercial starch of Tables 1 and 2 (i.e., INSCOSITY® B656) is identified as Commercial Products N and O in separate measurements in Table 3. For Commercial Products N and O, the pH of the pre-gelatinized suspension is less than about 7.0. An alternative commercial starch to the preferred commercial starch of Tables 1 and 2 is identified as Commercial Products P and Q in separate measurements in Table 3. For Commercial Products P and Q, the pH of the pre-gelatinized suspension is greater than about 7.0.

Comparison of moisture retention and percent shrinkage of various commercial starches, including the preferred commercial starch of Tables 1 and 2, is provided in Table 4 below. Cakes were made in accordance with the American Institute of Baking Standard Yellow Cake Formulation, and a starch was added to the batter as shown in Table 4. The preferred commercial starch of Tables 1 and 2, i.e., INSCOSITY® B656, is identified as Commercial Product AI in Table 4. Commercial Products AK is xanthan gum. Commercial Product AJ and AM are each a drum dried pre-gelled waxy maize, hydroxy propylated and crosslinked starch. Commercial Product AL is a spray cooked waxy, hydroxy propylated starch. As shown in Table 4, cake having Commercial Product AI is superior in moisture retention and has less shrinkage over time in freezer storage, and has better texture analyzer scores (i.e., less hardness) over time in the freezer (i.e., 9 months) or cakes having the other commercial starches. Cake having Commercial Product AI is also superior to cakes having other commercial starches in terms of cell structure in that it does not contain large holes (or tunneling) after 9 months in the freezer, compared to cakes having other commercial starches, which did have tunneling after 9 months in the freezer.

Comparison of moisture retention and percent shrinkage of various commercial starches, including the preferred commercial starch of Tables 1 and 2, is provided in Table 5 below. The preferred commercial starch of Tables 1 and 2, i.e., INSCOSITY® B656, is identified as Commercial Product AI in Table 5. The commercial starch identified as Commercial Product A in Table 3, which is drum dried waxy maize acetylated crosslinked starch, is identified as Commercial Product AN in Table 5. As shown in Table 5, cake having Commercial Product AI is superior in moisture retention and has less shrinkage over time in freezer storage, and has better texture analyzer scores (i.e., less hardness) over time in the freezer (i.e., 13 months) than cake having Commercial Product AN. Cake having Commercial Product AI did not have tunneling after 13 months in the freezer, unlike cake having Commercial Product AN, which did having tunneling after 13 months in the freezer.

Comparison of moisture retention and percent shrinkage of various commercial starches, including the preferred commercial starch of Tables 1 and 2, is provided in Table 6 below. The preferred commercial starch of Tables 1 and 2, i.e. INSCOSITY® B656, is identified as Commercial Product AI in Table 6. The commercial starch identified as Commercial Product K in Table 3, which is a spray cooked waxy hydroxyl propylated and crosslinked starch, is identified as Commercial Product AO in Table 6. As shown in Table 6, cake having Commercial Product AI is superior in moisture retention and has less shrinkage over time in freezer storage, and has better texture analyzer scores (i.e., less hardness) over time in the freezer (i.e., 18 months) than cake having Commercial Product AO. Cake having Commercial Product AI did not have tunneling after 18 months in the freezer, unlike cake having Commercial Product AO, which did having tunneling after 18 months in the freezer.

Comparison of moisture retention and percent shrinkage of various commercial starches, including the preferred commercial starch of Tables 1 and 2, is provided in Table 7 below. The preferred commercial starch of Tables 1 and 2, i.e., INSCOSITY® B656, is identified as Commercial Product AI in Table 7. The commercial starch identified as Commercial Product B in Table 3, which is a drum dried pre-gelatinized tapioca hydroxy propylated crosslinked starch, is identified as Commercial Product AP in Table 7. The commercial starch identified as Commercial Product AQ in Table 7 is an alcohol processed dent corn hydroxy propylated cross linked starch. The commercial starch identified as Commercial Product M in Table 3 is an alcohol processed waxy hydroxy propylated cross linked starch and is identified as Commercial Product AR in Table 7.

As shown in Table 7, cake having Commercial Product AI is superior in moisture retention and has less shrinkage, and has better texture analyzer scores (i.e., less hardness) over time at room temperature (i.e., 8 days) than cake having Commercial Product AP, AQ, and AR. These numbers suggest that in the freezer, cake having Commercial Product AI will hold up better in terms of moisture retention, less percent shrinkage, and less hardness than cake having the other commercial starches. Cake having Commercial Product AI did not have tunneling after 8 days at room temperature, unlike cake having Commercial Products AP, AQ, and AR, which did having tunneling after 8 days at room temperature.

TABLE 3
Comparison of Instant Starch Viscosity

| Starch | Manufacturing | Base | Dry Solids Basis | | | | | As is Basis | | | | |
|---|---|---|---|---|---|---|---|---|---|---|---|---|
| Name | Process | Starch | Initial | 10 min | 20 min | 30 min | 60 min | Initial | 10 min | 20 min | 30 min | 60 min |
| Commercial Product A | Drum Dried | Waxy | 1060 | 1230 | 1440 | 1760 | 2260 | 380 | 450 | 590 | 660 | 840 |
| Commercial Product B | Drum Dried | Tapioca | 5810 | 5940 | 6170 | 6500 | 6470 | 3590 | 3910 | 4130 | 4320 | 4960 |
| Commercial Product C | Drum Dried | Waxy | 12240 | 12040 | 12040 | 12960 | 12720 | 8950 | 8790 | 9690 | 10580 | 10660 |
| Commercial Product D | Drum Dried | Waxy | 1790 | 2000 | 2740 | 2930 | 3900 | 990 | 1110 | 1350 | 1700 | 2180 |
| Commercial Product E | Drum Dried | Waxy | 11420 | 12300 | 13720 | 13760 | 15180 | 6980 | 7650 | 8620 | 8910 | 9280 |
| Commercial Product F | Drum Dried | Waxy | 2760 | 2930 | 3140 | 3180 | 3790 | 1680 | 1890 | 2100 | 2260 | 2350 |
| Commercial Product G | Spray Cooked | Waxy | 1880 | 2010 | 2210 | 2520 | 3250 | 640 | 710 | 890 | 940 | 1500 |
| Commercial Product H | Spray Cooked | Tapioca | 1350 | 1870 | 2830 | 3590 | 4750 | 290 | 510 | 630 | 830 | 1490 |
| | did not disperse | | | | | | | | | | | |
| | well | | | | | | | | | | | |
| Commercial Product I | Spray Cooked | Waxy | 3670 | 3720 | 4380 | 4550 | 5010 | 1620 | 1930 | 2140 | 2330 | 2710 |
| Commercial Product J | Spray Cooked | Waxy | 11900 | 13780 | 15280 | 15400 | 14800 | 9590 | 10780 | 11620 | 11900 | 11220 |
| Commercial Product K | Spray Cooked | Waxy | 2560 | 2720 | 3210 | 3130 | 3970 | 930 | 1010 | 1290 | 1310 | 1740 |
| Commercial Product L | Spray Cooked | Waxy | 2950 | 2990 | 3700 | 3840 | 4010 | 1030 | 1100 | 1380 | 1580 | 2080 |
| Commercial Product M | Alcohol Process | Waxy | 7990 | 7850 | 7600 | 7520 | 7130 | 7020 | 6600 | 6380 | 6360 | 6290 |
| Commercial Product N | Spray Cooked | Dent | 3370 | 3510 | 3780 | 3900 | 4240 | 1410 | 1640 | 1880 | 2150 | 2300 |
| Commercial Product O | Spray Cooked | Dent | 3370 | 3510 | 4100 | 4340 | 4350 | 4000 | 4110 | 4200 | 4290 | 4390 |
| Commercial Product P | Spray Cooked | Dent | 6280 | 6390 | 6410 | 6380 | 6530 | 3590 | 3750 | 3960 | 4530 | 4390 |
| Commercial Product Q | Spray Cooked | Dent | 5570 | 6230 | 6260 | 6280 | 6300 | 3770 | 3990 | 4190 | 4090 | 4340 |
| Commercial Product R | Alcohol Process | Dent | 6030 | 6100 | 5780 | 5790 | 5650 | 3470 | 3230 | 3540 | 3450 | 3220 |
| Commercial Product S | Alcohol Process | Dent | 10500 | 10240 | 9300 | 9280 | 8770 | 6600 | 6400 | 6200 | 6200 | 5910 |

TABLE 4
Comparison of Starches

| | | Batter | | | | |
|---|---|---|---|---|---|---|
| | | Viscosity | Volume | | Shrinkage | Textural Analysis |
| Cake Variable | Date | Centipoise | cc | Moisture % | % Height | Hardness, grams |
| Control | Day 1, Room Temp. | 20,420 | 1551 | 27.8 | | 396.15 |
| | Day 8, Room Temp. | | | 22.7 | | 617.42 |
| | Frozen, 9 months | | | 24.6 | 13.4 | 493.59 |
| Commercial Product | Day 1, Room Temp. | 20,980 | 1579 | 27.3 | | 391.88 |
| AA 1% | Day 8, Room Temp. | | | 23.8 | | 606.76 |
| | Frozen, 9 months | | | 24.6 | 5.4 | 478.84 |
| Commercial Product | Day 1, Room Temp. | 20,373 | 1518 | 28.2 | | 435.12 |
| AB 1% | Day 8, Room Temp. | | | 26.7 | | 620.87 |
| | Frozen, 9 months | | | 27.1 | 12.4 | 462.92 |
| Commercial Product | Day 1, Room Temp. | 19,351 | 1515 | 27.2 | | 389.61 |
| AC 1% | Day 8, Room Temp. | | | 25.2 | | 630.86 |
| | Frozen, 9 months | | | 25.3 | 16.7 | 438.54 |
| Commercial Product | Day 1, Room Temp. | 22,500 | 1476 | 26.6 | | 378.84 |
| AD 1% | Day 8, Room Temp. | | | 25.8 | | 602.96 |
| | Frozen, 9 months | | | 25.5 | 31.3 | 510.53 |
| Commercial Product | Day 1, Room Temp. | 18,472 | 1544 | 26 | | 415.94 |
| AE 1% | Day 8, Room Temp. | | | 25 | | 603.42 |
| | Frozen, 9 months | | | 23.9 | 6.5 | 495.5 |
| Commercial Product | Day 1, Room Temp. | 16,342 | 1538 | 25.7 | | 353.85 |
| AF 1% | Day 8, Room Temp. | | | 24.7 | | 544.46 |
| | Frozen, 9 months | | | 23.7 | 11.3 | 491.42 |
| Commercial Product | Day 1, Room Temp. | 23,323 | 1509 | 29.6 | | 389.54 |
| AG 1% | Day 8, Room Temp. | | | 24.3 | | 587.16 |
| | Frozen, 9 months | | | 27.7 | 2.5 | 360.73 |
| Commercial Product | Day 1, Room Temp. | 28,014 | 1570 | 27 | | 341.39 |
| AH 1% | Day 8, Room Temp. | | | 25.9 | | 521.97 |
| | Frozen, 9 months | | | 25 | 10.4 | 415.93 |
| Commercial Product | Day 1, Room Temp. | 33,500 | 1520 | 28.9 | | 384.07 |
| AI 1% | Day 8, Room Temp. | | | 25.9 | | 567.24 |
| | Frozen, 9 months | | | 28.3 | 1.6 | 354.58 |
| Commercial Product | Day 1, Room Temp. | 27,340 | 1528 | 29.7 | | 417.5 |
| AI 0.5% | Day 8, Room Temp. | | | 25.8 | | 547.11 |
| | Frozen, 9 months | | | 23 | 5.4 | 477.95 |
| Commercial Product | Day 1, Room Temp. | 23,171 | 1570 | 27.9 | | 344.72 |
| AI 0.45% | Day 8, Room Temp. | | | 27.1 | | 505.1 |
| Commercial Product | Frozen, 9 months | | | 25 | 6 | 417.37 |
| AG 0.25% | | | | | | |
| Commercial Product | Day 1, Room Temp. | 48,900 | 1526 | 27 | | 391.75 |
| AJ 1% | Day 8, Room Temp. | | | 24.5 | | 571.52 |
| | Frozen, 9 months | | | 25.6 | 9.3 | 387.09 |
| Commercial Product | Day 1, Room Temp. | 29,320 | 1499 | 25.5 | | 409.14 |
| AK 0.10% | Day 8, Room Temp. | | | 19.6 | | 645.76 |
| | Frozen, 9 months | | | 24 | 10.8 | 503.01 |
| Commercial Product | Day 1, Room Temp. | 41,000 | 1510 | 29 | | 392.73 |
| AL 1% | Frozen, 6 months | | | 27.3 | 16.6 | 421.14 |
| Commercial Product | Day 1, Room Temp. | 38,380 | 1520 | 28.6 | | 360.81 |
| AM 1% | Day 8, Room Temp. | | | 25.3 | | 546.21 |
| | Frozen, 9 months | | | 26.8 | 5.8 | 414.95 |

TABLE 5
Comparison of Starches

| | | | | | | Textural |
|---|---|---|---|---|---|---|
| | | Batter | | | | Analysis |
| | | Viscosity | Volume | | Shrinkage | Hardness, |
| Cake Variable | Date | Centipoise | cc | Moisture % | % Height | grams |
| Control | Day 1, Room | 19,790 | 1663 | 27.7 | | 410.37 |
| | Temp. May 5, 2003 | | | | | |
| | Day 8, Room | | | 28.2 | | N/A |
| | Temp. May 13, 2003 | | | | | |
| | Frozen, 13 months | | | 25 | 10 | 443.95 |
| | (Jun. 4, 2004) | | | | | |
| Commercial Product | Day 1, Room | 25,754 | 1598 | 27.4 | | 392.84 |
| AI 1% | Temp. May 5, 2003 | | | | | |
| | Day 8, Room | | | 25 | | N/A |
| | Temp. May 13, 2003 | | | | | |
| | Frozen, 13 months | | | 25.7 | 1.3 | 342.95 |
| | (Jun. 4, 2004) | | | | | |
| Commercial Product | Day 1, Room | 33,651 | 1584 | 27 | | 394.86 |
| AN 1% | Temp. May 5, 2003 | | | | | |
| | Day 8, Room | | | 24.7 | | N/A |
| | Temp. May 13, 2003 | | | | | |
| | Frozen, 13 months | | | 23.1 | 6.1 | 411.62 |
| | (Jun. 4, 2004) | | | | | |

TABLE 6
Comparison of Starches

| | | | | | | Textural |
|---|---|---|---|---|---|---|
| | | Batter | | | | Analysis |
| | | Viscosity | Volume | | Shrinkage | Hardness, |
| Cake Variable | Date | Centipoise | cc | Moisture % | % Height | grams |
| Control | Day 1, Room Temp. | 20,560 | 1550 | 26.1 | | 349.37 |
| | Dec. 30, 2002 | | | | | |
| | Day 8, Room Temp. | | | 22.9 | | 556.06 |
| | Jan. 7, 2003 | | | | | |
| | Frozen, 18 months | | | 24 | 12.8 | 501.26 |
| | (Jun. 5, 2004) | | | | | |
| Commercial Product | Day 1, Room Temp. | 34,560 | 1535 | 27.9 | | 320.97 |
| AI 1% | Dec. 30, 2002 | | | | | |
| | Day 8, Room Temp. | | | 24.8 | | 538.39 |
| | Jan. 7, 2003 | | | | | |
| | Frozen, 18 months | | | 26.2 | 3 | 430.19 |
| | (Jun. 5, 2004) | | | | | |
| Commercial Product | Day 1, Room Temp. | 44,933 | 1510 | 28.5 | | 355.37 |
| AO 1% | Dec. 30, 2002 | | | | | |
| | Day 8, Room Temp. | | | 23 | | 576.49 |
| | Jan. 7, 2003 | | | | | |
| | Frozen, 18 months | | | 22.7 | 3.7 | 496.35 |
| | (Jun. 5, 2004) | | | | | |
| Commercial Product | Day 1; Room Temp. | 31,280 | 1590 | 26.1 | 3.4 | 322.5 |
| AO 0.75% | Dec. 30, 2002 | | | | | |
| | Day 8, Room Temp. | | | 23.8 | | 543.58 |
| | Jan. 7, 2003 | | | | | |
| | Frozen, 18 months | | | 22.7 | | 478.87 |
| | (Jun. 5, 2004) | | | | | |

TABLE 7
Comparison of Starches

| | | | | | | Textural |
|---|---|---|---|---|---|---|
| | | Batter | | | | Analysis |
| | | Viscosity | Volume | | Shrinkage | Hardness, |
| Cake Variable | Date | Centipoise | cc | Moisture % | % Height | grams |
| Control | Day 1, Room Temp. | 21,120 | 1575 | 28.9 | | N/A |
| | May 27, 2004 | | | | | |
| | Day 8, Room Temp. | | | 27.1 | | 566.62 |
| | Jun. 4, 2004 | | | | | |
| Commercial Product | Day 1, Room Temp. | 31,560 | 1525 | 31.4 | | N/A |
| AI 1% | May 27, 2004 | | | | | |
| | Day 8, Room Temp. | | | 28.8 | | 510.8 |
| | Jun. 4, 2004 | | | | | |
| Commercial Product | Day 1, Room Temp. | 37,200 | 1525 | 29.6 | | N/A |
| AP 1% | May 27, 2004 | | | | | |
| | Day 8, Room Temp. | | | 27 | | 541.7 |
| | Jun. 4, 2004 | | | | | |
| Commercial Product | Day 1, Room Temp. | 28,200 | 1525 | 30.7 | | N/A |
| AQ 1% | May 27, 2004 | | | | | |
| | Day 8, Room Temp. | | | 26.4 | | 558.69 |
| | Jun. 4, 2004 | | | | | |
| Commercial Product | Day 1, Room Temp. | 31,880 | 1500 | 30.5 | | N/A |
| AR 1% | May 27, 2004 | | | | | |
| | Day 8, Room Temp. | | | 26.8 | | 553.15 |
| | Jun. 4, 2004 | | | | | |

### EXAMPLE 3

In accordance with the invention, a pre-gelatinized starch is incorporated into a baked cake. A glaze may also be applied to the surface of the baked cake. The cake may also be flash-frozen.

All references cited herein are hereby incorporated by reference in their entireties. All methods described herein can be performed in any suitable order unless otherwise indicated herein or otherwise clearly contradicted by context. The use of any and all examples or exemplary language provided herein is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of reducing moisture loss in a frozen baked good comprising (a) preparing a baked good comprising a pre-gelatinized modified granular starch, and (b) freezing the baked good, said starch being present in said baked good in an amount effective to reduce moisture loss upon freezing relative to the absence of said starch.

2. The method of claim 1, wherein the pre-gelatinized modified granular starch is hydroxypropyl dent corn distarch phosphate.

3. The method of claim 1, wherein the baked good is frozen for a period of about two months to about nine months.

4. The method of claim 1, wherein the baked good comprises about 0.5% w/w to about 10% w/w of the pre-gelatinized modified granular dent corn starch.

5. The method of claim 4, wherein the baked good comprises about 0.75% w/w to about 1% w/w of the pre-gelatinized modified granular dent corn starch.

6. The method of claim 1, wherein the baked good is a high-ratio cake.

7. A method of reducing shrinkage of a frozen baked good, which method comprises (a) preparing a baked good comprising a pre-gelatinized modified granular starch and, (b) freezing the baked good, said starch being present in said baked good in an amount effective to reduce shrinkage upon freezing relative to the absence of said starch.

8. The method of claim 7, wherein the pre-gelatinized modified granular starch is hydroxypropyl dent corn distarch phosphate.

9. The method of claim 7, wherein the baked good is frozen for a period of about two months to about nine months.

10. The method of claim 7, wherein the baked good comprises about 0.5% w/w to about 10% w/w of the pre-gelatinized modified granular dent corn starch.

11. The method of claim 10, wherein the baked good comprises about 0.75% w/w to about 1% w/w of the pre-gelatinized modified granular dent corn starch.

12. The method of claim 7, wherein the baked good is a high ratio cake.
